(19) United States
(12) Patent Application Publication
(10) Pub. No.: US 2024/0294736 A1
(43) Pub. Date: Sep. 5, 2024

(54) Recyclable material

(71) Applicant: FluidSolids AG, Zürich (CH)

(72) Inventors: Beat Karrer, Zürich (CH); Angelika Zys, Adliswil (CH); Francesca Tancini, Neuenhof (CH)

(73) Assignee: FluidSolids AG, Zürich (CH)

(21) Appl. No.: 18/574,733

(22) PCT Filed: Jun. 23, 2022
(86) PCT No.: PCT/EP2022/067258

§ 371 Date: Dec. 27, 2023

(30) Foreign Application Priority Data
Jun. 29, 2021 (CH) 00756/21

(51) Int. Cl. C08L 1/02; B29B 7/38; B29B 9/06; B29B 13/06; B29C 43/00; B29C 45/00; B29C 48/00; B29C 48/05; B29K 1/00; B29K 67/00; B29K 105/00; B29K 105/16; C08K 5/053

(52) U.S. Cl. CPC C08L 1/02; B29B 7/38; B29B 9/06; B29B 13/065; C08K 5/053; B29C 43/003; B29C 43/006; B29C 45/0001; B29C 48/022; B29C 48/05; B29K 2001/00; B29K 2001/08; B29K 2067/00; B29K 2089/00; B29K 2105/0073; B29K 2105/16; C08L 2205/025; C08L 2205/035

(57) ABSTRACT

The present application relates to a recyclable material. The recyclable material comprises 30-97% by weight of cellulose material, 2-45% by weight of at least one protein binder, 1-20% by weight of at least one alcohol or ester and 0-45% by weight of at least one additive. Furthermore, the present application relates to a process for producing a recyclable material and to a molded part produced therefrom.

### TECHNICAL AREA

The invention relates to a recyclable material which is suitable for producing molded parts, a method for producing a molded part from the recyclable material and a molded part produced therefrom.

### BACKGROUND

Around 348 million tons of petroleum-based plastic were produced worldwide in 2017. Around half of this cheap and versatile material is processed into items that are only used once, such as bags, straws or disposable bottles. In relation to all the energy, labor and raw materials used to produce them, the benefits are often very short-lived. Many of these disposable items are not disposed of correctly and end up in the environment, especially in the sea, where they lie around for decades due to their low degradability. Furthermore, environmentally harmful chemicals, especially plasticizers, are sometimes washed out, which leads to water and soil pollution. Of the plastic items that are disposed of correctly, most are still incinerated or disposed of in landfill sites.

Another problem is that the manufacture of plastic products requires petroleum, a high amount of energy and fresh water. Therefore, petroleum-based plastics have a poor energy and environmental balance.

For some years now, plastics made from renewable, natural raw materials have therefore been increasingly used, particularly for the production of disposable items. The problem is that many of these plastics are primarily based on raw materials that are also used as foodstuffs, such as potatoes, rice or corn.

Many recyclable materials that could be used to produce disposable items, such as paper or cardboard, cannot be molded as easily as plastic material, making them unsuitable for mass production.

It would therefore be advantageous if a recyclable material were available that consists of natural raw materials that do not compete with foodstuffs, or only to a limited extent, and that can be processed as easily and in as many ways as a petroleum-based plastic materials.

### SUMMARY OF THE INVENTION

The object of the present invention is to provide a recyclable material which is suitable for shaping different molded parts, said material being easy to form into different shapes and recyclable or disposable in an environmentally friendly manner, in particular by means of composting, after use.

This object is solved by the features according to claim 1. According to the present invention, a recyclable material comprises 30-97% by weight of cellulose material, 2-45% by weight of at least one protein binder, 1-20% by weight of at least one alcohol or ester and 0-45% by weight of at least one additive.

The material consists entirely of natural raw materials and is therefore environmentally friendly. Due to the high content of cellulose material, the material or a molded part made from this material can be fed into the paper, cardboard or paperboard recycling cycle and can therefore be easily and repeatedly recycled. In addition, the material is fully compostable, even in household compost, enabling environmentally friendly disposal. By using a protein binder, the material can also be molded as easily as a thermoplastic.

In the present application, recyclable material is understood to mean a material which can be processed and whose main component, in this case the cellulose material, can then be used as a starting material for the production of new material, in this case for paper, cardboard or paperboard.

The recyclable material according to the present invention or a molded part formed therefrom can be dissolved in water, e.g. in a pulper, whereby the cellulose material can then be separated and further processed into paper, cardboard or paperboard. The other components present in the recyclable material are preferably completely biodegradable or present in such small quantities that they are unproblematic, such that the material can be disposed of easily and in an environmentally friendly manner, in particular via waste water. Furthermore, the protein binder and any other components of the recyclable material may also be isolated and reused using suitable processing methods.

It has been shown that with the recyclable material according to the invention, a high proportion of the cellulose material can be fed into the recycling cycle. Test series carried out by the applicant have shown values of over 95% recyclability of the cellulose material.

If the recyclable material or a molded part made therefrom is not to be recycled, it can be completely decomposed in compost. The materials used allow complete degradation both in household compost and in industrial compost in accordance with the standards of DIN/EN 13432:2000. In addition, the recyclable material or a molded part made therefrom is harmlessly degradable in nature and in water in accordance with the specifications of ISO 16221:2001.

The recyclable material exhibits thermoplastic properties during processing, in particular when a solvent such as water is added or when exposed to heat, and can therefore be processed into molded parts using the methods known from polymer processing, for example by injection molding, extrusion, pressing, casting, rotational molding or vacuum forming. The material may also be processed into a molded part using sintering or a 3D printer.

The recyclable material according to the present invention thus provides an environmentally friendly alternative to petroleum-based plastics.

The cellulose material is preferably in the form of fibers or a powder. If the cellulose material is present as a powder, the powder has an average particle size of 100-1000 μm, preferably 150-250 μm.

The cellulose material is preferably present in an amount of 30-97% by weight, particularly preferably 40-90% by weight, especially preferably 51-85% by weight, most preferably 60-80% by weight in the recyclable material.

In the present application, a protein binder is understood to be a protein or a protein mixture that has the properties of an adhesive and which may be hardened. Protein binders can soften when heat is applied and/or water is added, thereby allowing to reshape the recyclable material. By using at least one protein binder, a thermoplastic behavior of the recyclable material according to the present invention can thus be achieved.

The at least one protein binder is preferably present in the recyclable material in a concentration of 2-45 wt. %, more preferably 10-30 wt. %, particularly preferably 15-25 wt. %.

The at least one alcohol and/or the at least one ester improves the flowability of the recyclable material according to the present invention, which facilitates the processing of the recyclable material into a molded part.

The recyclable material comprises 1-20 wt. %, preferably 3-17 wt. %, particularly preferably 6-15 wt. % of at least one alcohol and/or ester.

Depending on the application, the recyclable material according to the present invention may comprise at least one additive. The at least one additive can be used to add an additional physical, optical, tactile or chemical property to the recyclable material or to specifically alter such a property. For example, the recyclable material can be colored with a dye or pigments. The at least one additive is preferably biodegradable and/or recyclable.

Preferably, at least one colorant or at least one color pigment is used as an additive, in particular charcoal, a vegetable colorant, preferably from a vegetable or a fruit, e.g. beet or carrot.

The recyclable material according to the present invention can be used to produce any molded parts, in particular packaging, filling material, furniture parts, articles of daily use, decorative articles, cutlery, plates, bags, etc.

The cellulose material preferably comprises cellulose, a cellulose derivative, lignin, paper or cardboard or a mixture thereof.

Used paper and/or cardboard can thus also be used for the recyclable material according to the present invention. As a result, the recyclable material or a molded part made therefrom can be integrated into the recycling cycle of paper and cardboard, such as to allow a particularly resource-saving and environmentally friendly production thereof. Preferably, cellulose material originating from a recyclable material according to the invention or a molded part produced therefrom which has been dissolved in water can also be used as cellulose material. Therefore, the cellulose material of the recyclable material according to the present invention may also be reused for the production of new recyclable material according to the present invention.

Preferably, methyl cellulose or hydroxymethyl cellulose is used as a cellulose derivative. The cellulose may be in the form of cellulose fibers, microcellulose or hemicellulose.

Preferably, the at least one protein binder comprises a vegetable protein binder, in particular from cereals, soy, almond, hemp, peas, lupine, pumpkin, cassava, sunflower or a mixture thereof.

The grain is preferably wheat, rye, barley, oats, rice, maize, millet or a mixture thereof.

Preferably, the protein binder comprises at least one animal protein binder, in particular a glutine glue, gelatine, collagen, keratin, casein, albumin or a mixture thereof.

The glutine glue is preferably bone glue, hide glue, rabbit glue, fish glue or a mixture thereof.

The at least one alcohol preferably has 1 to 50 carbon atoms. The alcohol is preferably an alcohol with 2 to 30 carbon atoms, in particular with 2 to 15 carbon atoms.

The at least one alcohol can be linear or branched. The at least one alcohol can be a monohydric alcohol, but is preferably a polyhydric alcohol, in particular with 2 to 15 hydroxy groups, preferably from 2 to 10 hydroxy groups, in particular from 2 to 6 hydroxy groups.

Preferably, the at least one alcohol is selected from polyglycerol-3 (CAS 25618-55-7), glycerol ethoxylate (CAS 316954-55-0), pentaerythriole ethoxylate (CAS 30599-15-6), polyethylene glycol E400 (CAS 25322-68-3), glycerol (CAS 56-81-5), 1,2-propanediol (CAS 57-55-6), dipentaerythritol (CAS 126-58-9), pentaerythritol (CAS 115-77-5), ethylene glycol (CAS 107-21-1), diethylene glycol (CAS 111-46-6), triethylene glycol (CAS 112-27-6), or a mixture thereof.

The at least one ester is preferably a carboxylic acid ester and preferably has from 2 to 22 carbon atoms, in particular from 6 to 12 carbon atoms. The at least one ester can be a monoester, but is preferably a polyester. In particular, the at least one ester is preferably an alklycitrate or glycerol acetate, in particular triethyl citrate (CAS 77-93-0) or glycerol triacetate (CAS 102-76-1).

Preferably, the recyclable material according to the present invention comprises starch, at least one monosaccharide, at least one oligosaccharide or at least one polysaccharide or a mixture thereof as the at least one additive. Such sugar compounds act as an additional binder in the recyclable material, whereby the strength of the recyclable material can be increased or the amount of the at least one protein binder can be reduced while maintaining the same strength of the material.

Preferably, the at least one additive is selected from wheat starch, potato starch, rice starch, tapioca starch, dextrins, agar, alginates, pectins, chitin, cyclodextrins or mixtures thereof. Further preferably, the additive may comprise saccharides from extracts of algae, fruits, vegetables and/or cereals.

Preferably, the at least one additive comprises glucose, fructose, galactose, sucrose, maltose, lactose, maltodextrin, dextrose, isomalt, erythritol, mannitol, xylitol, sugar syrups, invert sugar syrups or a mixture thereof.

Preferably, the at least one additive comprises sorbitol (CAS 50-70-4), xylitol (CAS 87-99-0), mannitol (CAS 69-65-8), sucrose (CAS 57-50-1), trehalose (CAS 6138-23-4) or a mixture thereof.

Preferably, the at least one additive comprises of the recyclable material comprises urea and/or allantoin. This improves the flow properties of the recyclable material before it dries or hardens, making it easier to process the recyclable material into a molded part, e.g. during casting.

The at least one additive of the recyclable material preferably comprises a preservative. This allows the recyclable material to be stored for a longer time before it is processed into a molded part.

Preferably, the additive is selected from ascorbic acid or citric acid or salts thereof, a sorbate, plant extracts or a mixture thereof.

Alternatively, the additive comprises methyl 4-hydroxybenzoate or propyl 4-hydroxybenzoate. However, as these substances are not biodegradable, they are only used in small quantities at a maximum of 0.3% by weight, which means that the recyclable material as a whole can still be composted in accordance with standards, while the environment as well as water are not endangered.

Preferably, the recyclable material comprises at least one animal or vegetable fat as the at least one additive. The addition of a fat can improve the granulation of the recyclable material.

The at least one fat preferably is linseed oil, castor oil, rapeseed oil, sunflower oil, fat powder, a medium-chain triglyceride or a mixture thereof.

Preferably, at least one additive of the recyclable material comprises at least one natural wax, in particular carnauba wax, candelilla wax, sugar cane wax, beeswax or stearin or a mixture thereof.

Preferably, the at least one additive of the recyclable material comprises at least one mineral. Preferably, the at least one mineral is mica, wollastonite, iron oxide, bentonite, hydromagnesite, chalk, gypsum, lithopone, huntite, talc, magnesium oxide, magnesium carbonate, kaolin, calcium carbonate, vermiculite, silicates, perlite or a mixture thereof.

The addition of at least one mineral can influence the mechanical properties of the recyclable material or a molded part made therefrom. Furthermore, the addition of at least one mineral can achieve pigmentation or coloring of the recyclable material and improve the homogeneity of a surface of a molded part made therefrom. In addition, the flow properties of the recyclable material can be specifically improved by the at least one mineral.

The present application also relates to a method for producing a molded part from a recyclable material. In a first step, from 30 to 97% by weight of cellulose material, 2 to 45% by weight of at least one protein binder, 1 to 20% by weight of at least one alcohol or ester, and 0 to 45% by weight of at least one additive and water as solvent are provided in a mixer. The components are then mixed with the mixer to form the recyclable material, from which the molded part is then formed.

Depending on the protein binder, the protein binder must be dissolved in warm or boiling water first. Components in the form of a powder are preferably dissolved in water first, depending on the type of component along with heating and/or agitation.

The mixer preferably is a planetary agitator, eccentric screw pump, propeller agitator, disk agitator, extruder or magnetic stirrer.

The components are preferably mixed from 1 to 40 minutes, preferably from 1 to 10 minutes.

Preferably, the recyclable material is extruded into a strand after mixing and the molded part is then formed from the strand of recyclable material, wherein the formed molded part is subsequently dried.

Preferably, the recyclable material is preferably extruded into a strand after mixing and the strand is crushed into a granulate, wherein the molded part is formed from the granulate and the formed molded part is subsequently dried.

The granulate is preferably dried. The granulate is preferably stored before the molded part is formed. During storage, the granulate can be transported. This offers the advantage that the granulate and the molded part can be produced at different geographical locations and at different times.

The granulate may for example be heated to form the molded part, eventually under elevated pressure. Alternatively, the granulate may also be liquefied using a suitable solvent, preferably water, before molding.

Preferably, the extrusion is carried out at a pressure of 40 to 180 bar, preferably 60 to 140 bar, particularly preferably 80 to 120 bar.

Preferably, the recyclable material is dried after mixing and crushed into a powder, in particular a powder with a particle size of less than 0.10 mm, especially less than 0.05 mm, and the molded part is then formed from the powder.

Preferably, the powder is stored before the molded part is formed. The powder can be transported during storage. This offers the advantage that the powder and the molded part may be produced at different geographical locations and at different times.

The powder can be heated to form the molded part, for example, even under pressure. Alternatively, the powder can also be liquefied using a suitable solvent, preferably water, before molding. If the material is liquefied before the molded part is formed, the molded part is dried after forming.

The powder made from the recyclable material according to the invention is particularly suitable for shaping the molded part by means of 3D printing, in particular by means of multi-jet modelling.

Preferably, the molded part is formed by pressing, casting, extrusion, rotational molding, vacuum forming, injection molding, sintering or 3D printing.

The present application also relates to a molded part made of a recyclable material as described above.

The molded part is preferably a packaging, filling material, furniture part, utility item, decorative item, cutlery, plate or bag.

Further advantageous embodiments and combinations of features of the invention result from the following detailed description and the entirety of the patent claims.

### EXAMPLES

### Example 1

In a first example, approx. 134 g of rabbit glue was mixed with 250 g of boiling water and heated to 70° C. in a water bath for 20 minutes. 101 g casein from bovine milk (13.5-15% nitrogen content) was then added to the mixture and mixed vigorously to form the binder component.

40 g glucose and 16 g magnesium sulphate were dissolved in boiling water (glucose in 40 g water and magnesium sulphate in 20 g water) and added to the binder component and mixed. When the mixture was homogeneous, 1.6 g of methyl 4-hydroxybenzoate and propyl 4-hydroxybenzoate (69:31) were added and mixed.

The intermediate was mixed with liquid additives and fiber, i.e. 64 g sorbitol, 12 g castor oil were added to the mixture and mixed vigorously. Finally, 432 g of fiber (hydroxypropylmethylcellulose and cellulose of approx. 200 μm, in a ratio of 50:50) were added and mixed vigorously in a planetary agitator (rotor agitator 10 L).

The material was extruded into a strand in a hydraulic press (Lindenberg press 60 tons) at a pressure of approx. 140 bar through a pressing device consisting of a piston and a ram with a nozzle of 2 mm diameter. After drying, the strand was cut into pieces of 2 mm in length and the resulting granulate was then injection molded into a molded part, which was then dried.

| | Weight % | |
|---|---|---|
| | against total | |
| Material | quantity | Quantity [g] |
| Rabbit glue | 16.7 | 133.608 |
| Casein | 12.6 | 100.792 |
| Hydroxypropylmethylcellulose | 27 | 216 |
| HPMC | | |
| Cellulose 200 μm | 27 | 216 |
| Parabene | 0.2 | 1.6 |
| Sorbitol | 8 | 64 |
| Glucose | 5 | 40 |
| Magnesium sulphate MgSO₄ | 2 | 16 |
| Castor oil | 1.5 | 12 |
| Total all components | 100 | 800 |

### Example 2

In a second example, 1.6 g of potassium benzoate and 16 g of magnesium sulphate were dissolved in 250 g of boiling water. Then 116 g of glycerol was added to the mixture.

234 g gluten protein (with typical nutritional information: 80 wt % protein, 3.8 wt % fiber, 5.8 wt % fat, 4.7 wt % carbohydrates, 0.13 wt % salt) was mixed with 416 g cellulose fiber (of approx. 150 μm).

The powdery mixture and the liquid mixture were mixed together to obtain a binder component.

Finally, 16 g of nut oil was added and mixed vigorously in a planetary agitator.

The material was extruded into a strand in a hydraulic press at a pressure of approx. 140 bar through a pressing device comprising a piston and a plunger with a nozzle of 2 mm diameter. After drying, the strand was cut into pieces of 2 mm in length and the resulting granulate was then injection molded into a molded part, which was then dried.

| | Weight % | |
|---|---|---|
| | against total | |
| Material | quantity | Quantity [g] |
| Gluten | 29.3 | 234.4 |
| Cellulose 150 μm | 52 | 416 |
| Potassium benzoate | 0.2 | 1.6 |
| Glycerol | 14.5 | 116 |
| Magnesium sulphate MgSO₄ | 2 | 16 |
| Nut oil | 2 | 16 |
| Total components | 100 | 800 |

### Example 3

In a third example, 109.2 g of soy protein isolate (with typical nutritional information: 90 wt % protein, 1.5 wt % fat, 1.8 wt % carbohydrate, 0.5 wt % salt) was mixed with 109.2 g of tapioca starch (with typical nutritional information: 0.2 wt. % protein, <0.1% fat, 87.8% carbohydrates, <0.1% salt), 40 g xanthan gum, 2 g of a mixture of methyl 4-hydroxybenzoate and propyl 4-hydroxybenzoate (69:31) and 416 g cellulose fibers (of approx. 150 Mm) in a bowl.

28 g of glucose and 16 g of magnesium sulphate were dissolved in boiling water (glucose in 50 g of water and magnesium sulphate in 20 g of water) and added to the powdery mixture and mixed well. Then 71 g sorbitol and 8 g coconut oil were added and mixed vigorously.

300 g of boiling water was added to the previously mixed components and mixed with a sufficiently powerful planetary agitator.

The material was extruded into a strand in a hydraulic press at a pressure of approx. 140 bar through a pressing device comprising a piston and a punch with a nozzle of 2 mm diameter. After drying, the strand was cut into pieces of 2 mm length and the resulting granulate was then injection molded into a molded part, which was then dried.

| | Weight % | |
|---|---|---|
| | against total | |
| Material | quantity | Quantity [g] |
| Soy protein | 13.65 | 109.2 |
| Tapioca starch | 13.65 | 109.2 |
| Cellulose 150 μm | 52 | 416 |
| Parabens | 0.3 | 2 |
| Sorbitol | 8.9 | 71 |
| Glucose | 3.5 | 28 |
| Magnesium sulphate MgSO₄ | 2 | 16 |
| Xanthan gum | 5 | 40 |
| Coconut oil | 1 | 8 |
| Total components | 100 | 800 |

### Example 4

In a fourth example, 16 g lactose, 24 g maltodextrin, 1.6 g potassium benzoate and 16 g magnesium sulphate were dissolved in 330 g boiling water. Then 107.2 g of fish glue was added, mixed and heated to 70° C. in a water bath for 20 minutes.

107.2 g gluten protein (with typical nutritional information: 80 wt % protein, 3.8 wt % fiber, 5.8 wt % fat, 4.7 wt % carbohydrates, 0.13 wt % salt) was mixed with 480 g cellulose fiber (of approx. 150 μm).

40 g of 1,2-propanediol and 8 g of nut oil were added to the liquid mixture.

The powdered mixture and the liquid mixture were mixed together.

The material was extruded into a strand in a hydraulic press at a pressure of approx. 140 bar through a pressing device comprising a piston and a punch with a nozzle of 2 mm diameter. After drying, the strand was cut into 2 m long pieces and the resulting granulate was then injection molded into a molded part, which was then dried.

| | Weight % | |
|---|---|---|
| | against total | |
| Material | quantity | Quantity [g] |
| Gluten Protein | 13.4 | 107.2 |
| Fish glue | 13.4 | 107.2 |
| Cellulose 150 μm | 60 | 480 |
| Potassium benzoate | 0.2 | 1.6 |
| 1,2-propanediol | 5 | 40 |
| Lactose | 2 | 16 |
| Magnesium sulphate MgSO₄ | 2 | 16 |
| Maltodextrin | 3 | 24 |
| Nut oil | 1 | 8 |
| Total components | 100 | 800 |

### Example 5

In a fifth example, 134 g of gelatine was mixed with 310 g of boiling water and heated to 70° C. in a water bath for 20 minutes.

Then 100.8 g albumin was mixed with pea protein isolate 1:1 (with typical nutritional information: 80 wt. % protein, 5.5 wt. % fat, 2.6 wt. % carbohydrates, 1.9 wt. % salt) and approx. 38 g maltodextrin.

The powdered mixture and the liquid mixture were mixed together to obtain a binder component.

16 g magnesium sulphate was dissolved in 20 g boiling water and added to the mixture together with 80 g 1,2-propanediol and mixed.

Finally, 432 g of fiber (cellulose approx. 200 μm) was added and mixed vigorously with a planetary agitator.

The material was extruded into a strand in a hydraulic press at a pressure of approx. 140 bar through a pressing device comprising a piston and a punch with a nozzle of 2 mm diameter. After drying, the strand was cut into 2 mm long pieces and the resulting granulate was then injection molded into a molded part, which was then dried.

| | Weight % | |
|---|---|---|
| | against total | |
| Material | quantity | Quantity [g] |
| Gelatine | 16.7 | 133.61 |
| Albumin | 6.3 | 50.40 |
| Pea protein isolate | 6.3 | 50.40 |
| Cellulose 200 μm | 54 | 432 |
| 1,2-propanediol | 10 | 80 |
| Maltodextrin | 4.7 | 37.6 |
| Magnesium sulphate MgSO4 | 2 | 16 |
| Total components | 100 | 800.01 |

### Processing the Recyclable Material by Sintering

A quantity of granulate of the recyclable material was placed in a pressing tool with the contour of the molded part to be produced. The tool was heated to a temperature of 150° C. in a heated press, the granulate was filled in and pressed for 2 minutes at a pressure of 1 kg/cm². The tool with the molded part was then removed from the press, cooled to a temperature of 50° C. and then the manufactured molded part was removed.

Alternatively, powder can also be used for processing by sintering.

### Processing the Recyclable Material by Extrusion

Granulate from the recyclable material was processed into profiles with various cross-sections using an extrusion system (Weber ES45) with a short compression screw at an operating temperature of 120°−140° C.

### Processing the Recyclable Material Using 3D Printing

A powder made from the recyclable material was filled into the designated container of a 3D printer that works according to the multi-jet modeling process (ZPrinter© 150 from 3DSystems) and the original binder from Z-Corp was replaced with water. After the printing process, the molded part was removed and dried.

We claim:

1.-18. (canceled)

19. A recyclable material suitable for molding, comprising:
30-97% by weight cellulose material;
2-45% by weight of at least one protein binder;
1-20% by weight of at least one alcohol and/or at least one ester; and
0-45% by weight of at least one additive.

20. The recyclable material according to claim 19, wherein the cellulose material comprises cellulose, a cellulose derivative, lignin, paper or cardboard or a mixture thereof.

21. The recyclable material according to claim 19, wherein the at least one protein binder comprises a vegetable protein binder or a mixture thereof.

22. The recyclable material according to claim 19, wherein the protein binder comprises at least one animal protein binder.

23. The recyclable material according to claim 19, wherein the at least one alcohol has 1 to 50 carbon atoms.

24. The recyclable material according to claim 19, wherein the at least one additive comprises starch, at least one monosaccharide, at least one oligosaccharide or at least one polysaccharide or a mixture thereof.

25. The recyclable material according to claim 19, wherein the at least one additive comprises urea or allantoin.

26. The recyclable material according to claim 19, the at least one additive comprises a preservative.

27. The recyclable material according to claim 19, wherein the at least one additive comprises at least one animal fat or vegetable fat.

28. The recyclable material according to claim 19, wherein the at least one additive comprises at least one natural wax.

29. The recyclable material according to claim 19, wherein the at least one additive comprises at least one mineral.

30. A method for producing a molded part from a recyclable material, comprising the steps of:
providing 30-97% by weight of cellulose material, 2-45% by weight of at least one protein binder, 1-20% by weight of at least one alcohol or ester, and 0-45% by weight of at least one additive in a mixer with adding water as solvent;
mixing the components in the mixer to create the recyclable material; and
forming the molded part from the recyclable material.

31. The method according to claim 30, wherein the recyclable material is extruded into a strand after mixing and the molded part is subsequently formed from the strand of the recyclable material, the molded part being subsequently dried.

32. The method according to claim 30, wherein the recyclable material is extruded into a strand after mixing and the strand is crushed into a granulate, the molded part being subsequently formed from the granulate, and the molded part being subsequently dried.

33. The method according to claim 31, wherein the extrusion is carried out at a pressure of from 40 to 180 bar.

34. The method according to claim 30, wherein the recyclable material is dried after mixing and comminuted to a powder and the molded part is then formed from the powder.

35. The method according to claim 30, wherein the molded part is formed by pressing, casting, extrusion, rotational molding, vacuum molding, injection molding, sintering or 3D printing.

36. A molded part made of the recyclable material according to claim 19.

37. The recyclable material according to claim 22, wherein the at least one animal protein binder is a glutin glue, gelatine, collagen, keratin, casein, albumin or a mixture thereof.

38. The recyclable material according to claim 28, wherein the at least one natural wax comprises carnauba wax, candelilla wax, sugar cane wax, beeswax or stearin or a mixture thereof.

39. The recyclable material according to claim 29, wherein the at least one mineral comprises mica, wollastonite, iron oxide, bentonite, hydromagnesite, chalk, gypsum, lithopone, huntite, talc, magnesium oxide, magnesium carbonate, kaolin, calcium carbonate, vermiculite, silicates, perlite or a mixture thereof.
